(19) United States
(12) Patent Application Publication
(10) Pub. No.: US 2005/0119917 A1
(43) Pub. Date: Jun. 2, 2005

(54) Unified medical information management system and method thereof

(76) Inventor: Il-Kon Kim, Buk-gu (KR)

Correspondence Address: SHERIDAN ROSS PC, 1560 BROADWAY, SUITE 1200, DENVER, CO, 80202, US

(21) Appl. No.: 10/961,825

(22) Filed: Oct. 7, 2004

(30) Foreign Application Priority Data
Nov. 28, 2003 (KR) 10-2003-0085643

(51) Int. Cl. G06F 17/60

(52) U.S. Cl. 705/2

(57) ABSTRACT

Disclosed is a unified medical information management system and method capable of sharing and utilizing medical information that includes personal diagnosis and treatment information in conjunction with medical facilities and their associated companies, as well as interfacing medical records between the medical facilities and personal communication apparatuses by way of a communication network. The system includes a communication network interface, a plurality of medical facility data terminals storing diagnosis and treatment information of patients, and a medical information managing home system by which the personal diagnosis and treatment information is transferred to oneself from the medical facility data terminal through the communication network interface. The medical facility data terminal transmits coded diagnosis and treatment information in a predetermined message format. The medical information managing home system includes a database storing transmitted diagnosis and treatment information and an exclusive encoding/decoding processor. According to the invention, a patient can manage his own case records and analyzes the validity of the diagnosis and treatment information. If necessary, by providing one's medical information to another medical facility, it is possible to be of benefit in a personal or pedigree-specific medical service and to store and manage technical information useful for development of remedies.

### CROSS-REFERENCE TO RELATED APPLICATIONS

This U.S. non-provisional patent application claims priority under 35 U.S.C. § 119 of Korean Patent Application 2003-85643 filed on Nov. 28, 2003, the entire contents of which are hereby incorporated by reference.

### BACKGROUND OF THE INVENTION

The present invention is concerned with medical information management, specifically with a unified medical information management system and method for sharing and utilizing medical information that includes personal diagnosis and treatment records in conjunction with medical facilities and their associated companies, as well as interfacing medical records between the medical facilities and personal communication apparatuses by way of a communication network.

When a person is being treated in medical attention, a medical staff usually manages patient's diagnosis and treatment information by writing it on paper or storing it in a personal computer. The patient takes a prescription from a physician and then obtains a prescribed medicine from a drugstore in compliance with the prescription.

Meanwhile, the recent technical advancement and generality of communication apparatuses such as personal computers, mobile communication terminals, and so on is increasingly influencing overall affairs in society, even extending to medical fields, leading to actively progress developments for medical information technologies beginning with studies about inter-hospital networks for ‘paperless hospital’ and their relevant sides.

As medical information standard for networking among medical facilities, there is HL7 (Health Level 7). The HL7, as a set of rules that enables information to be exchangeable between software applications of different health and medical fields, is ranking as a global standard over the world, by which it is available to utilize all kinds of medical affair services regardless of types and scales of medical facilities. In other words, the HL7 is a network standard capable of sharing diagnosis and treatment information of patients.

The protocol of the HL7 specifies elements such a message structure, a coding rule, and a trigger event. Here, the message structure means an abstract definition of a message, the coding rule sets forms of message expression for transmission, and the trigger event means an application event to make a message generated. In the HL7, if there is an event by the trigger event, a networking route is established, through a network, among al least more than two systems to execute a data exchange operation by the event. Then, after completing a data transfer with a message type from one system to the other system, the receiving system sends a acknowledge message confirming safe receipt to the sending system and thereby one cycle is terminated.

The HL7 defines messages involved in various duties provided by medical facilities, such as patient affair managements, inquiries, prescriptions, and reports of observation records for prescription and clinical results, product experiments, waveform results, requests of patients, financial managements, scheduling, and so on.

As such, the HL7 is used to share diagnosis and treatment information about patients, which may provide higher-quality services for patients and expectably contribute to advancement of the medical science on the basis of the serious diagnosis and treatment effects.

However, the current networking between medical facilities is on a level of just sharing information among medical facilities and does not provide individuals with ways of independently managing personal medical records themselves. If a patient has an allergy to a specific drug, it is necessary for the patient to inform a medical staff of the allergic symptoms when he is diagnosed and treated or requiring of compounding medicines in compliance with a prescription. Such an action may be repeated every time there are diagnosis and treatment.

Moreover, it is inconvenience for a patient having more than two diseases to surely inform a medical staff of what kinds of diseases he catches and what kinds of medicines he takes. Unless such notices are properly conducted, there may be troubles such as a bad effect on the patient or a medical accident.

Further, in case that patient take medicines other than prescribed by a physician, they have the difficulty and inconvenience in verifying whether those medicines are good for their diseases and it may happen the misuses and abuses of medical products and social problems therefrom.

### SUMMARY OF THE INVENTION

The present invention is directed to solve the aforementioned problems and demerits, providing a unified medical information management system and method for storing personal medical information in individual home systems from medical facilities and if necessary, referring to the personal medical information stored in the home systems.

The present invention provides a unified medical information management system and method for inputting resultant data of diagnosis and treatment by medical facilities into an individual home system and verifying the validity of the result of the diagnosis and treatment by means of an intelligent decision supporting system, which prevents medical accidents in advance.

The present invention provides a unified medical information management system and method for obtaining statistical materials and resultant data of diagnosis and treatment for serious diseases, as well as offering high-quality medical services to patients, by sharing patients' medical information by way of network communication among medical facilities.

The present invention provides a unified medical information management system and method for enabling medical services focusing on individuals and pedigrees in accordance with management for family case records and gathering fundamental materials to transfer the pattern of medical service to an individual-specified medical treatment era from a symptomatic medical treatment era by accumulating, storing, and managing heritable information for the development of remedies.

A unified medical information management system according to the present invention includes: a plurality of medical facility data terminal associated with a communication interface and storing diagnosis and treatment information of a patient; and a medical information management home system receiving individual diagnosis and treatment information from the medical facility data terminal by way of the communication interface. The medical facility data terminal transfers the coded diagnosis and treatment information in a predetermined form of message. The medical information management home system includes: a database for storing the diagnosis and treatment information; and an exclusive coding and decoding processor for decoding the coded diagnosis and treatment information transferred from the medical facility data terminal.

It is available that the medical facility data terminal transfers the diagnosis and treatment information to a personal portable terminal and the portable terminal transfers the diagnosis and treatment information to the medical information management home system of individual.

### BRIEF DESCRIPTION OF THE DRAWINGS

The accompanying drawings are included to provide a further understanding of the invention, and are incorporated in and constitute a part of this specification. The drawings illustrate exemplary embodiments of the present invention and, together with the description, serve to explain principles of the present invention. In the drawings:

FIG. 1 is a block diagram illustrating the structure of a unified medical information management system in accordance with the present invention;

FIG. 2 is a block diagram illustrating the structure of a medical facility data terminal shown in FIG. 1;

FIG. 3 is a flow chart explaining a method of unified medical information management in accordance with the present invention;

FIG. 4 is a flow chart explaining a method of storing medical information in accordance with the present invention;

FIG. 5 is a block diagram illustrating exemplary composition of a network for sharing information among medical facility data terminals shown in FIG. 1;

FIG. 6 is a block diagram illustrating another exemplary composition of a network for sharing information among medical facility data terminals shown in FIG. 1;

FIG. 7 is a flow chart explaining a method of sharing information in the network shown in FIG. 5;

FIG. 8 is a flow chart explaining a method of sharing information in the network shown in FIG. 6;

FIG. 9 is a block diagram illustrating modified composition of a network for sharing information among medical facility data terminals shown in FIG. 5; and

FIG. 10 is a block diagram illustrating another modified composition of a network for sharing information among medical facility data terminals shown in FIG. 6.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

Hereinafter, it will be described about an exemplary embodiment of the present invention in conjunction with the accompanying drawings. In the following description of the embodiments, ‘medical information’ means all kinds of information relative to personal physical and mental health including diagnosis and treatment records, health condition records, information of prescription with Western and Chinese medicines, and so forth.

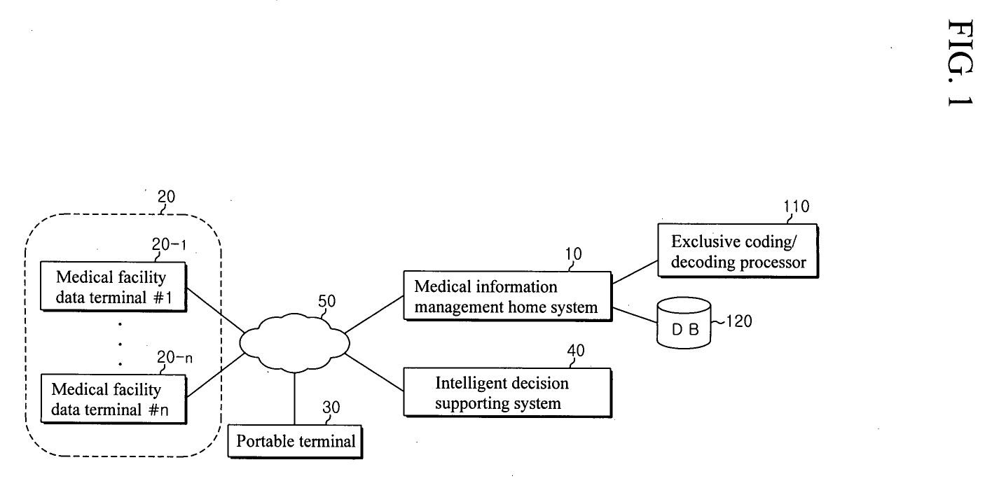

FIG. 1 is a block diagram illustrating the structure of a unified medical information management system in accordance with the present invention.

As shown in FIG. 1, the unified medical information management system includes a medical information management home system 10, a medical facility data terminal 20, a personal mobile terminal 30, and an intelligent decision supporting system 40. The medical facility data terminal 20 is composed of a plurality of terminals 20-1 and 20-n those are connectable from each other through a network.

The medical information management home system 10 may be implemented by means of a personal computer and is associated with an exclusive coding and decoding processor 110 and a database 120, receiving medical information directly from the medical facility data terminal 20 or receiving medical information, which has been transferred to the portable terminal 30 from the medical facility data terminal 20, from the portable terminal 30, and storing the medical information in the data base 120 to update data.

Here, the portable terminal 30 may be one of terminals such as a smart card, a mobile communication terminal having a smart card chip, a post-PC, and a portable PC exclusive to medical information. The mobile communication terminal means a communication terminal operable in a radio communication environment, such as a cellular phone, PCS, PDA, and so on.

As the medical information is permitted to be read only by medical staff or a patient himself or a guardian, communication between the medical facility data terminal 20 and the medical information management home system 10, and between the medical facility data terminal 20 and the portable terminal 30, should be made in a regularized network protocol and a specified message format. For this reason, the processor 110 is required for the medical facility data terminal 20, the portable terminal 30, and the medical information management home system 10 to process coding and decoding operations with documents of the medical information of the predetermined message format.

Such protocol and message format may be, for example, arranged with the form defined by HL7. The medical facility data terminal 20 stores medical information inputted by medical staff, using a document generating program according to the HL7 protocol, e.g., by means of a clinical document architecture (CDA) generator combined with an HL7 interface engine or tool kit, or a CDA generator by itself.

The medical facility data terminal 20 also transfers the personal medical information directly to the medical information management home system 10 by way of a communication network 50 or the portable terminal 30 with the HL7 interface by way of a communication network 50. And then an individual who received his own medical information transfers it to the medical information management home system 10 from the portable terminal 30 by way of the communication network 50.

In this embodiment, the communication network 50 means all kinds of networks applicable to data transmission such as the internet, radio communications, independent networks, and so forth.

From the consolidative storage and management of the personal medical information in the medical information management system 10, there are advantages as follows.

As an example, for a patient who has been diagnosed and treated in a medical facility #1, the diagnosis and treatment information is transferred through the medical facility data terminal #1 20-1 to the medical information management home system 10 owned by the patient. Afterward, when the patient has himself examined and treated in another medical facility #n, the medical facility #n is able to access to the medical information management home system 10 of the patient and refer to the medical information of the patient therein, which may enable a prescription to be optimized to a current condition of the patient.

As another case, if a medical facility #x is a drugstore, a patient who has been diagnosed and treated in the medical facility #1 may request a suitable remedy by transferring his own medical information to the medical facility #x after storing his own medical information into the medical information management home system 10. Further, the patient is able to receive notices about internal usage (or dosage) and information of prescribed medicines from the medical facility data terminal #x and utilize those notices in taking his medicines.

In a preferred embodiment of the present invention, the unified medical information management system may further include an intelligent decision supporting system 40 that is connectable to the medical information management home system 10 by way of the communication network 50.

The intelligent document supporting system 40, as a system for analyzing the validity of the diagnosis and treatment information in response to a request of a user after storing the diagnosis and treatment information, which is obtained from the medical facility data terminal 20, into the medical information management home system 10, checks out erroneous data of the medical information with reference to the database 120 of the medical information management home system 10 that contains the past history of the user as a patient, details of currently dosing medicines, and current health, and provides the checking result.

While the intelligent decision supporting system 40 can be configured with connection to the medical information management home system 10 by way of the communication network 50 as illustrated in FIG. 1, it is also feasible to download and install decision supporting software, which is made by the medical facility, into the medical information management home system 10 and then to use it as like the intelligent decision supporting means. The intelligent decision supporting system 40 or the intelligent decision software defines the condition of standard treatment and decision, and provides cautions or advices after verifying whether diagnosis and treatment information, arising from an independent event as an input of medical information written by the standard of diagnosis and treatment knowledge representation syntax, is fit for the condition of standard treatment and decision.

The intelligent decision supporting system 40 is preferred to automatically detect addition of user's medical information to the medical information management home system 10, and verify the added medical information with reference to preliminary stored information of the user, and then inform the user of the validity of the added medical information in real time. The result of verification of the medical information may be transferred to the medical information management home system 10 or the portable terminal 30.

Such units employed in the unified medical information management system, such as the medical facility data terminal 20, the medical information management home system 10, and the portable terminal 30, may be comprised of their exclusive viewers to display medical information.

Further, the medical information management home system 10 is able to manage the case records in the unit of family. From managing the case records of family as a whole, it is possible to conduct a pedigree-dependent medical service that is able to treat patients in accordance with constitutional tendencies and reduce the probability of attacks in heritable diseases, and to accumulate and manage heritable information for development of remedies for specific diseases.

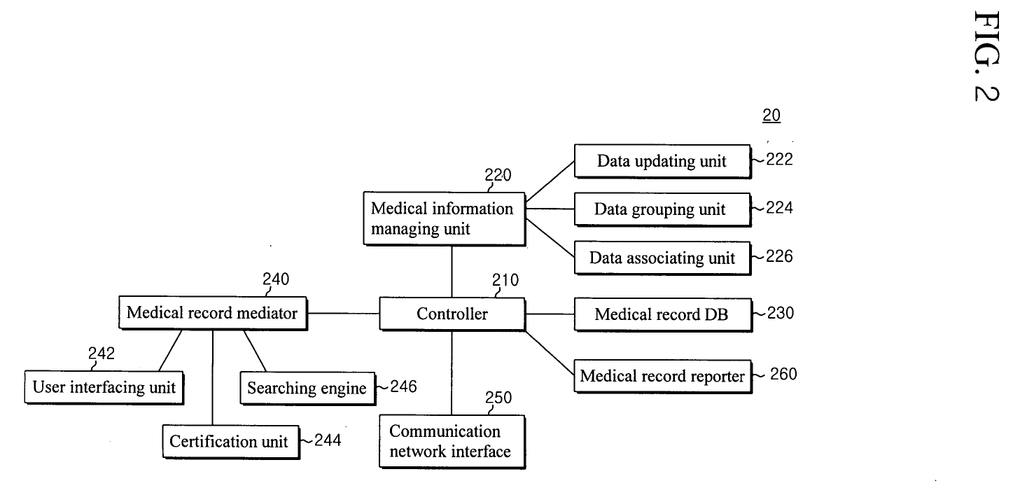

FIG. 2 is a block diagram illustrating the structure of the medical facility data terminal 20 shown in FIG. 1.

Referring to FIG. 2, the medical facility data terminal 20 is comprised of a controller 210, a medical record managing unit 220, a medical record database 230, a medical record mediator 240, a communication interface 250, and a medical record reporter 260. The medical record managing unit 220 includes a data updating unit 222, a data grouping unit 224, and data associating unit 226, and the medical record mediator 240 includes a user interface 242, a certification unit 244, and a searching engine 246. The user interface 242 is connected to data input and output units such as a keyboard, a display, and so on, intermediating data transceiving operations between the data terminal 20 and a user (a medical staff).

A medical staff inputs details of diagnosis and treatment through the user interface 242 of the medical information mediator 240. The input details of diagnosis and treatment are stored in the medical record database 230 by the medical record managing unit 220. At this time, if a patient has himself diagnosed and treated for the first time, the medical record managing unit 220 creates a new database for the patient. If a patient has himself diagnosed and treated again, the data updating unit 222 of the medical record managing unit 220 modify, adds, or corrects diagnosis and treatment information of the patient and then stores the modified information into the database 230.

In addition, it is preferred to verify an authorized user by the certification unit 244 before writing the diagnosis and treatment information in order to prevent the generation and update of records by an unauthorized user. It is preferred for the medical record managing unit 220 to use a clinical document architecture (CDA) generator combined with an HL7 interface engine or a tool kit, or CDA generator by itself in transforming the information and then to store the transformed information into the database 230, in order to prevent the outflow of the diagnosis and treatment information.

After storing the diagnosis and treatment information of a patient in the medical record database 230, a medical staff transfers the diagnosis and treatment information to the portable terminal 30 or the medical information management home system 10 of the patient, by way of the communication network interface 250. During this, it is desirable to use a communication method using the HL7 interface.

On the other side, when a medical staff desires to search diagnosis and treatment information of a patient, the certification unit 244 of the medical record mediator 240 confirms, for the protection of personal information, whether the user accessing to the medical facility data terminal 20 is authorized. For the authentification, every user permitted to access the medical facility data terminal 20 shall be assigned with identification (ID) and a password, or provided with a certification.

If a user (a medical staff) desiring to search the diagnosis and treatment information is proved as an authorized one from the confirmation by the certification unit 244, the user requires the diagnosis and treatment information by inputting key words to the searching engine 246. The searching engine 246 finds and outputs corresponding diagnosis and treatment information through the medical record reporter 260.

The medical record managing unit 220 includes, the data grouping unit 224 classifying the diagnosis and treatment information into various categories such as kinds of diseases, symptoms, ages of patients, etc., and the data associating unit 226 which examines relations among a variety of diagnosis and treatment information, such as symptoms according to kinds of diseases and the reverse. With results obtained by the data grouping and associating units, 224 and 226, it enables advanced medical services such as an improvement in treatment, a provision of statistical materials, and so on.

The medical record reporter 260 operates as an intermediating unit for making the medical facility data terminals 20-1˜20-n share data, as well as it has a function of searching diagnosis and treatment information in response to a request of the medical record mediator 240. That is, when the medical facility data terminals 20-1˜20-n are connected by way of the communication network 50, the medical record reporter 260 searches the medical record database 230 for diagnosis and treatment information requested from another medical facility and transfers the information to the data terminal of the medical facility which requested the information. It will be described later about the features of sharing data and connection among the medical facility data terminals 20-1˜20-n.

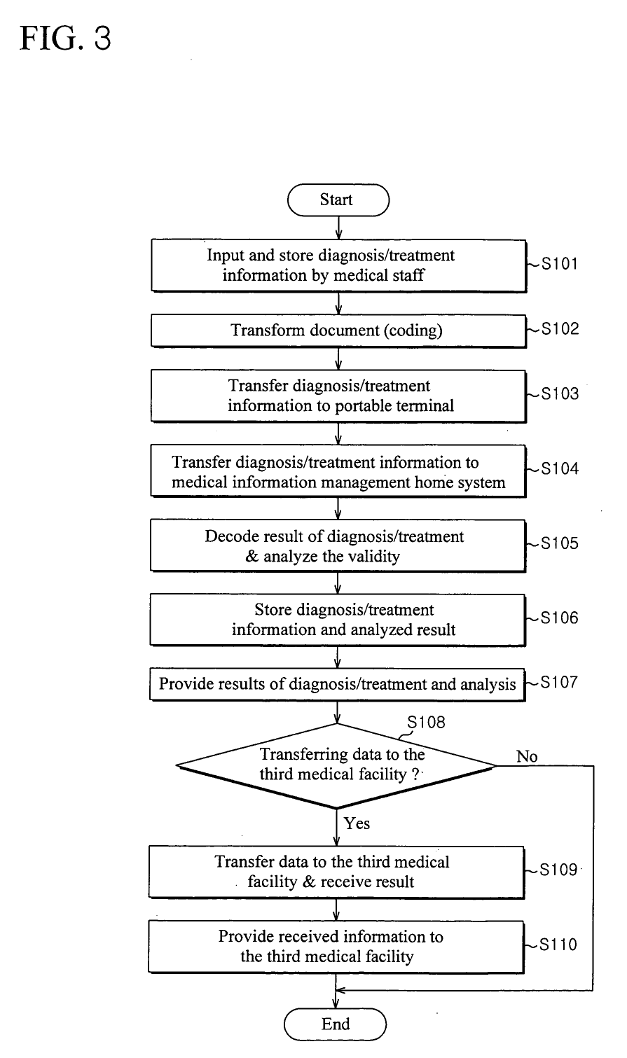

FIG. 3 is a flow chart explaining a method of unified medical information management in accordance with the present invention.

First, when a person goes to a medical facility, a designated medical staff examines and treats the person and the result of diagnosis and treatment is stored in the medical facility data terminal 20 (step S101). At this time, the diagnosis and treatment information is stored after it is transformed in a predetermined document format in order to protect personal information (step S102). In this embodiment of the present invention, the diagnosis and treatment information is stored by means of a CDA generator combined with the HL7 interface engine or a tool kit, or a CDA generator by itself.

Subsequently, the medical facility data terminal 20 transfers the diagnosis and treatment information to the portable terminal 30 of the user (step S103). During this, it is preferable to use the communication method employing the HL7 interface. Next, the user transfers the diagnosis and treatment information, which is temporarily stored in the portable terminal 30 of his own, to the medical information management home system 10 of his own (step S104). Also, during this, the communication method with the HL7 interface is used.

The diagnosis and treatment information is stored in the medical information management home system 10 and then decoded by the exclusive coding and decoding processor 110. The intelligent decision supporting system 40 recognizes the decoding of the diagnosis and treatment information and analyzes the validity of the diagnosis and treatment information on the basis of the user's case records previously stored in the medical information management home system 10 and sends the analyzed result to the medical information management home system 10 (step S105). The medical information home system 10 stores the analyzed result of the intelligent decision supporting system 40 into the database 120. Here, the intelligent decision supporting system 40 may be implemented as an independent system connectable to the communication network 50, or as a program embedded in the medical information management home system 10. The analyzed result of the diagnosis and treatment information, provided by the intelligent decision supporting system 40, may be displayed on the medical information management home system 10 or transferred to the portable terminal 30 for the user.

Afterward, when the user requires his own diagnosis and treatment information of the medical information management home system 10, the medical information management home system 10 displays the diagnosis and treatment information of the user (step S107).

In the present invention, it is available for the diagnosis and treatment information generated from the medical facility data terminal 20 to be stored directly in the medical information management home system 10 of the user by way of the communication network 50 without passing through the portable terminal 30.

After the step S107 for providing the diagnosis and treatment information to the user, it is possible to transmit his own diagnosis and treatment information to the third medical facility such as a drugstore in response to the user's request (step S108). In this case, the third medical facility such as a drugstore writes out a prescription reference document containing information of medicines to be prescribed and the guidance of dosage (usage) on basis of the received diagnosis and treatment information, and then transfers the prescription reference document to the medical information management home system 10 (step S109). The medical information management home system 10 receives and displays the prescription reference document so as to make the user read it (step S110). It is also possible for the medical information management home system to transfer the prescription reference document, which is received from the third medical facility such as a drugstore, to the portable terminal 30 of the user.

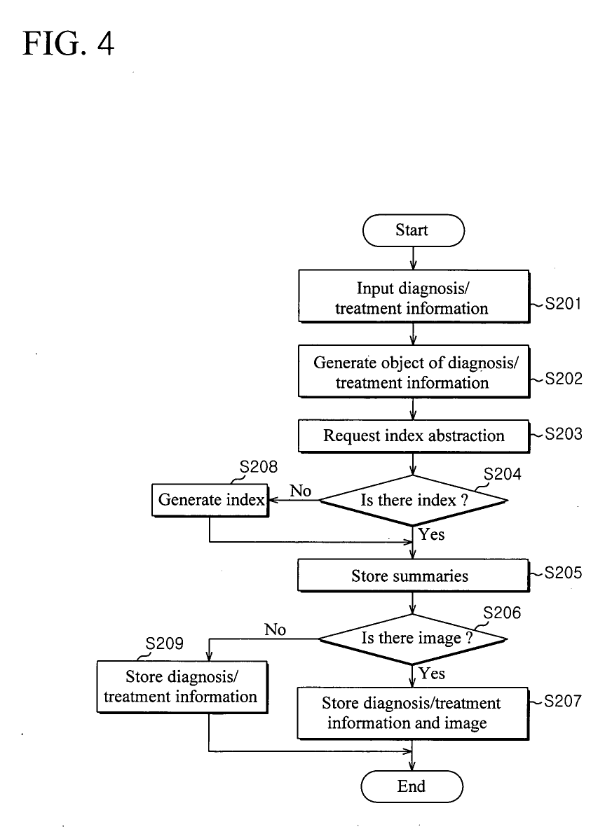

FIG. 4 is a flow chart explaining a method of storing medical information in accordance with the present invention.

In storing a result of diagnosis and treatment by a medical staff (or a medical staff) for a user who comes into a medical facility, the medical staff inputs diagnosis and treatment information through the user interface 242 of the medical facility data terminal 20 (step S201). During this, it is possible to accompany with a step of verifying whether the user inputting the information is an authorized user. The user authentification may be carried out with previously established identification and password, or with a certification issued by a certification facility.

The diagnosis and treatment information inputted by the medical staff may contain texts or images, and for protection of personal information, the medical record managing unit 220 of the medical facility data terminal 20 transforms the diagnosis and treatment information inputted by the medical staff using a CDA generator combined to an HL7 interface engine or a tool kit, or a CDA generator by itself (step S202).

After then, when the medical staff needs to store the diagnosis and treatment information, the medical record managing unit 220 requests a search for previous diagnosis and treatment records of the user to be diagnosed and treated (step S203). That is, it requests confirming whether there is a diagnosis and treatment record previously stored by an index such as a username or a resident registration number (or a social identification number). Accordingly, the medical record managing unit 220 of the medical facility data terminal 20 confirms the presence of a user index (step S204), and stores a summary document of a current result of diagnosis and treatment into the medical record database 230 (step S205) if there is the user index.

The medical record managing unit 220 confirms whether an image is included in the diagnosis and treatment information inputted by the medical staff (step S206), and stores the diagnosis and treatment information into the database 230 together with the image (step S207) if there is an image.

During the step S204 of confirming the presence of the user index in the medical record database 230, if there is no index, the step S205 of storing the summary document is carried out after creating an index (step S208). In the step S206 of confirming the inclusion of an image, if there is no image in the diagnosis and treatment information, only the diagnosis and treatment information is stored in the database 230 (step S209).

In the aforementioned method of storing the medical record or information, the databases for storing the summaries and details of the diagnosis and treatment information may be consolidated into a single unit or independent units by each.

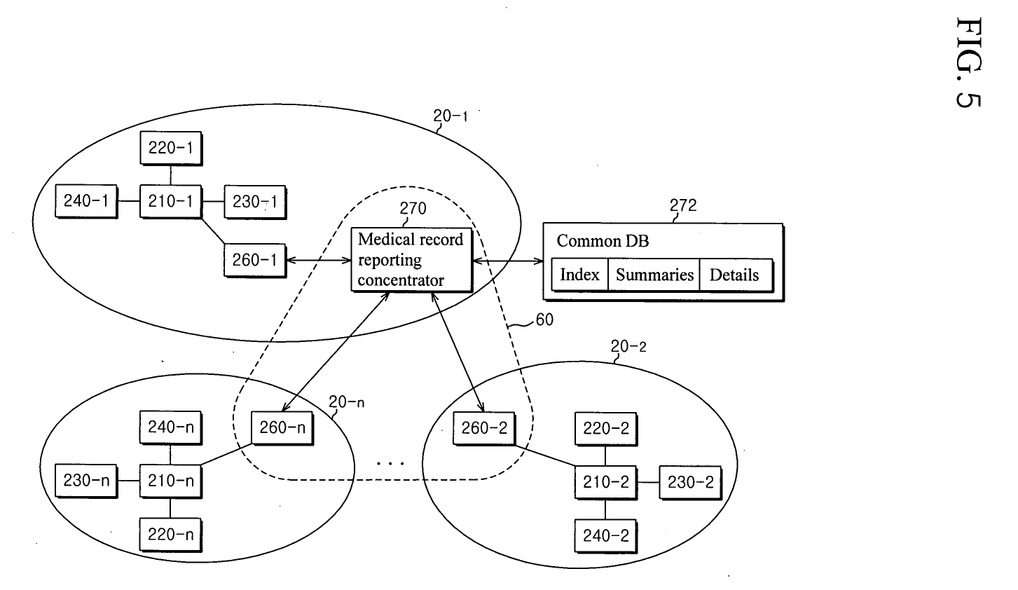

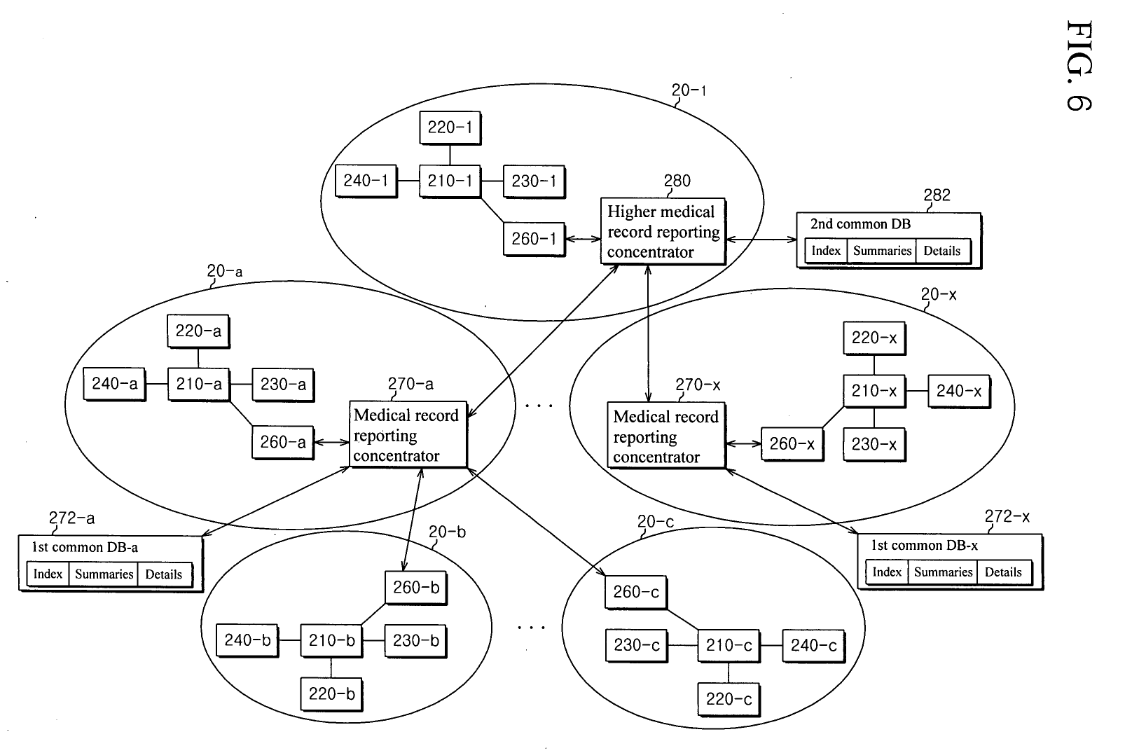

FIG. 5 is a block diagram illustrating exemplary composition of a network for sharing information among medical facility data terminals shown in FIG. 1, and FIG. 6 is a block diagram illustrating another exemplary composition of a network for sharing information among medical facility data terminals shown in FIG. 1.

FIGS. 5 and 6 shows, when the medical facility data terminal 20 is arranged in a plurality of terminals 20-1˜20-n, the features of interconnections for sharing the medical information between the medical facility data terminals 20-1˜20-n, which is accomplished by the medical record reporter 260 shown in FIG. 2.

First, referring to FIG. 5, the plural medical facility data terminals 20-1˜20-n are connectively arranged in the form similar to a primary tree structure. One of the medical facility data terminals 20-1˜20-n, e.g., 20-1, has a medical record reporting concentrator 270 to share the diagnosis and treatment information. As a matter of convenience, the medical facility data terminal 20-1 having the medical record reporting concentrator 270 will be referred to as “higher medical facility data terminal”, while the other medical facility data terminal 20-2˜20-n as “lower medical facility data terminals”.

In this embodiment, the medical record reporting concentrator 270 includes a common database 272 that manages summaries and details about the medical information stored in the higher (i.e., by itself) and lower medical facility data terminals in the classes of indexes. In other words, the common database 272 stores and manages the information about the medical facility data terminals where a summary document for a certain patient and its detailed information are stored, and it is possible to store practical contents of the summary and detail in accordance with cases.

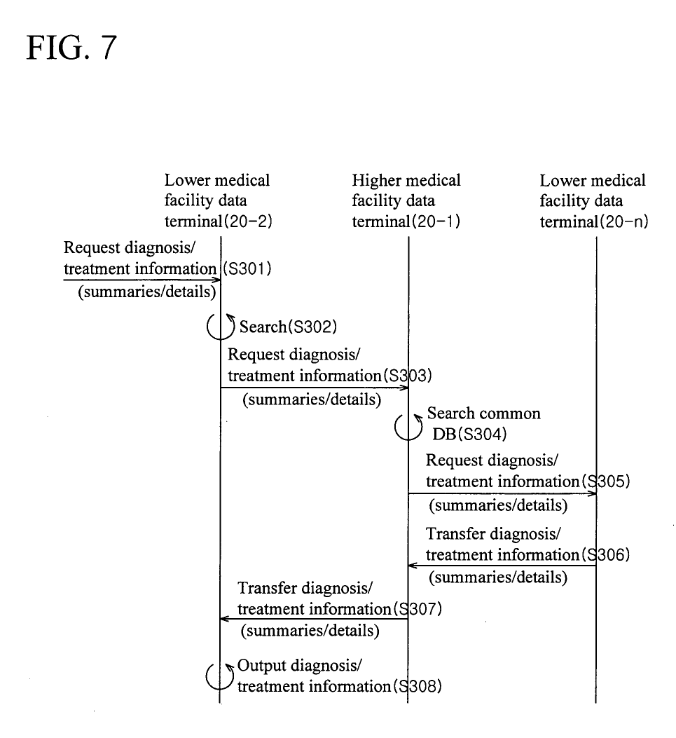

Referring to FIG. 7, the plural medical facility data terminals 20-1˜20-n are connected to each other by way of their own communication network interfaces. For example, when a user of the lower medical facility data terminal 20-2 requests diagnosis and treatment information by way of the medical record mediator 240-2 (step S301), the medical record mediator 240-2 requires a search for the diagnosis and treatment information of the medical record reporter 260-2. Here, the diagnosis and treatment information required by the user may be a summary and/or a detail. The medical record reporter 260-2 confirms searches the database 230-2 to confirm whether the diagnosis and treatment information required by the user is stored in the database 230-2 (step S302).

If the database 230-2 does not have the diagnosis and treatment information required by the user, the medical record reporter 260-2 requests the diagnosis and treatment information (summaries and/or details) from the medical record reporting concentrator 270 of the higher medical facility data terminal 20-1 (step S203). Accordingly, the medical record reporting concentrator 270 of the higher medical facility data terminal 20-1 refers to the common database 272 (step S304).

After referring to the common database 272 of the medical record reporting concentrator 270, if the diagnosis and treatment information (summaries and/or details) required by the lower medical facility data terminal 20-2 exists in the lower medical facility data terminal 20-n, the higher medical facility data terminal 20-1 requests the diagnosis and treatment information (summaries and/or details) from the lower medical facility data terminal 20-n (step S305) and receives the diagnosis and treatment information (summaries and/or details) from the lower medical facility data terminal 20-n (step S306). During this, the lower medical facility data terminal 20-n received a request for the diagnosis and treatment information is able to further prosecute verifying whether the higher medical facility data terminal 20-1 requiring the diagnosis and treatment information is an authorized information requester. In addition, it is preferred to receive the information of the medical facility data terminal 20-2, which requests the diagnosis and treatment information for the first time, from the higher medical facility data terminal 20-1 and to store and manage it as an history of providing the diagnosis and treatment information.

Afterward, when the diagnosis and treatment information is transferred to the lower medical facility data terminal 20-2 (step S307), the lower medical facility data terminal 20-2 outputs the received diagnosis and treatment information (step S308).

The aforementioned networking scheme with the primary tree architecture is efficient when the number of the medical facility data terminals 20-1˜20-n is not quite large, but it may be incapable of assuring a normal data rate when the number of the medical facility data terminals 20-1˜20-n increases. In order to overcome the limits according to the number of the data terminals, the multiple tree architecture is usefully provided as shown in FIG. 6. While FIG. 6 proposes a secondary tree architecture, it is possible to implement a networking system with a more multiplied tree architecture along an increase of the number of the medical facility data terminals 20-1˜20-n.

Referring to FIG. 6, the primary tree is constructed of the medical facility data terminals 20-a through 20-x that include the medical record reporting concentrator 270 by a higher medical record reporting concentrator 280 that is regarded as a higher level than the medical record reporting concentrator 270. The secondary tree is constructed of the medical facility data terminals 20-b through 20-c that do not include the medical record reporting concentrator 270 by a medical report reporting connector 270-a˜270-x.

For the convenience in description, it refers the medical facility data terminal 20-1 having the higher medical record reporting concentrator 280 to as the highest medical facility data terminal, the medical facility data terminals 20-a˜20-x having the medical record reporting concentrator 270-a˜270-x to as the higher medical facility data terminals, and the medical facility data terminals 20-b˜20-c without the medical record reporting concentrator 270 to as the lower medical facility data terminals.

In this embodiment, the medical record reporting concentrators 270-a and 270-x comprise the primary common databases 271-a and 272-x, respectively, for managing summaries and details of the medical information stored in themselves (i.e., the higher medical facility data terminals) and the lower medical facility data terminals (e.g., 20-b through 20-c for 20-a) by indexes. Further, the higher medical record reporting concentrators 280 includes the secondary common databases 282, respectively, for managing summaries and details of the medical information stored in itself (i.e., the highest medical facility data terminal) and the higher medical facility data terminals by indexes. Here, the primary and secondary common databases may store practical contents of the medical information, together with the summaries and details.

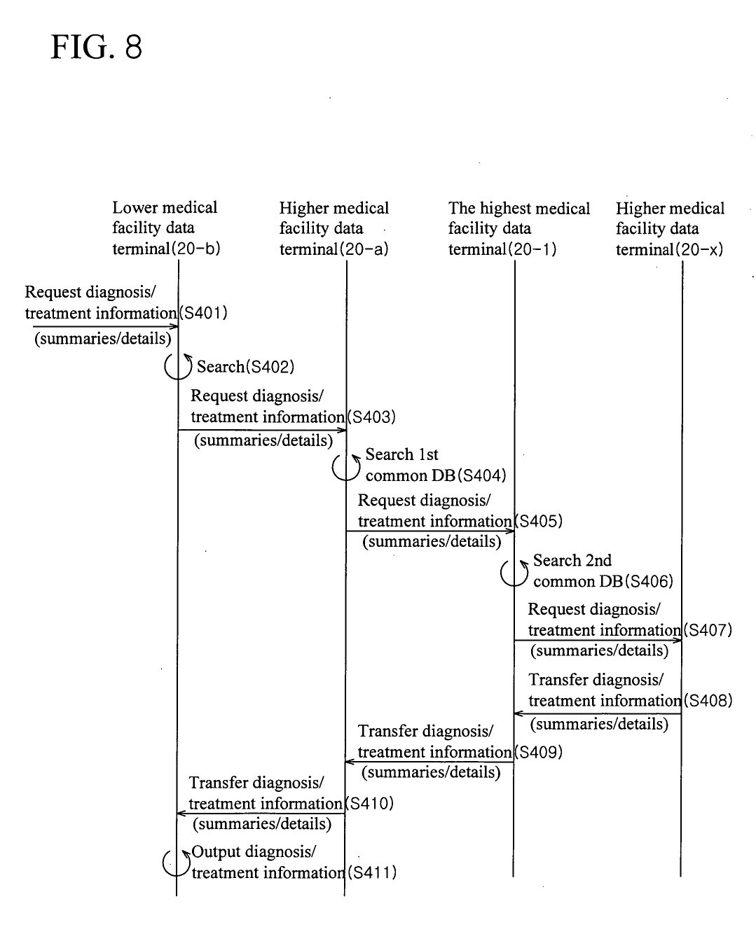

Referring to FIG. 8 for more detailed description about the operation, in the condition that plural medical facility data terminals 20-1˜20-n are connected to each other by way of the communication network interface, if a user of the lower medical facility data terminal 20-b requires diagnosis and treatment information through the medical record mediator 240-b (step S401), the medical record mediator 240-b requests a search for the diagnosis and treatment information from the medical record reporter 260-b. Here, the diagnosis and treatment information required by the user may be summaries and/or details. The medical record reporter 260-b searches the database 230-b to confirm whether the diagnosis and treatment information required by the user is stored in the database 230-b (step S402).

If the database 230-b does not have the diagnosis and treatment information required by the user, the medical record reporter 260-b requests the diagnosis and treatment information from the medical record reporting concentrator 270-a of the higher medical facility data terminal 20-a (step S403). According as that, the medical record reporting concentrator 270-a of the higher medical facility data terminal 20-a refers to the primary common database and confirms which of the lower medical facility data terminal has summaries and/or details of the diagnosis and treatment information required by the user (step S404).

After referring to the primary common database 272-a by the medical record reporting concentrator 270-a, if it is confirmed that the lower medical facility data terminal (20-c, etc.) does not have the diagnosis and treatment information requested by the lower medical facility data terminal 20-b, the higher medical facility data terminal 20-a requests the diagnosis and treatment information to the higher medical record reporting concentrator 280 of the highest medical facility data terminal 20-1 (step S405). Accordingly, the higher medical record reporting concentrator 280 of the highest medical facility data terminal 20-1 refers to the secondary common database and confirms which of the higher medical facility data terminal stores summaries and/or details of the diagnosis and treatment information requested by the higher medical facility data terminal 20-a (step S406).

From referring to the secondary common database by the higher medical record reporting concentrator 280, if it is confirmed that the higher medical facility data terminal 20-x contains the diagnosis and treatment information requested by the higher medical facility data terminal 20-a, the highest medical facility data terminal 20-1 requests summaries and/or details of the diagnosis and treatment information to the higher medical facility data terminal 20-x (step S407) and receives the diagnosis and treatment information from the higher medical facility data terminal 20-x (step S408). During this, the higher medical facility data terminal 20-a requested for the diagnosis and treatment information is able to further prosecute an operation of confirming whether the highest medical facility data terminal 20-1 requesting the diagnosis and treatment information is authorized. In addition, it is preferable to receive information about the lower medical facility data terminal 20-b which requested the diagnosis and treatment information for the first time and about the higher medical facility data terminal 20-a from the highest medical facility data terminal 20-1, and to store and manage the information as a history of providing diagnosis and treatment information.

After then, the higher medical record reporting concentrator 280 of the highest medical facility 20-1 transfers the diagnosis and treatment information (summaries and/or details), which is received from the higher medical facility data terminal 20-x, to the higher medical facility data terminal 20-a (step S409). The higher medical facility data terminal 20-a transfers the diagnosis and treatment information to the lower medical facility data terminal 20-b (step S410). The lower medical facility data terminal 20-b outputs the received diagnosis and treatment information.

As described above, when the number of the medical facility data terminals 20-1˜20-n is large, the multiple tree architecture contributes to enhancing the speeds of searching and transferring data, rather than those by the primary tree architecture.

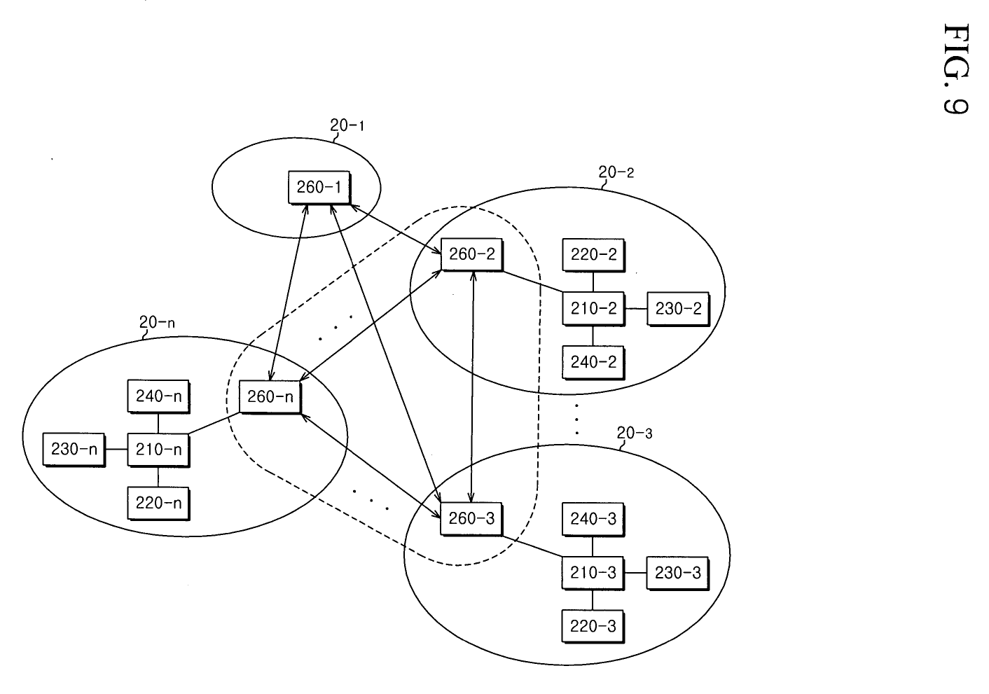

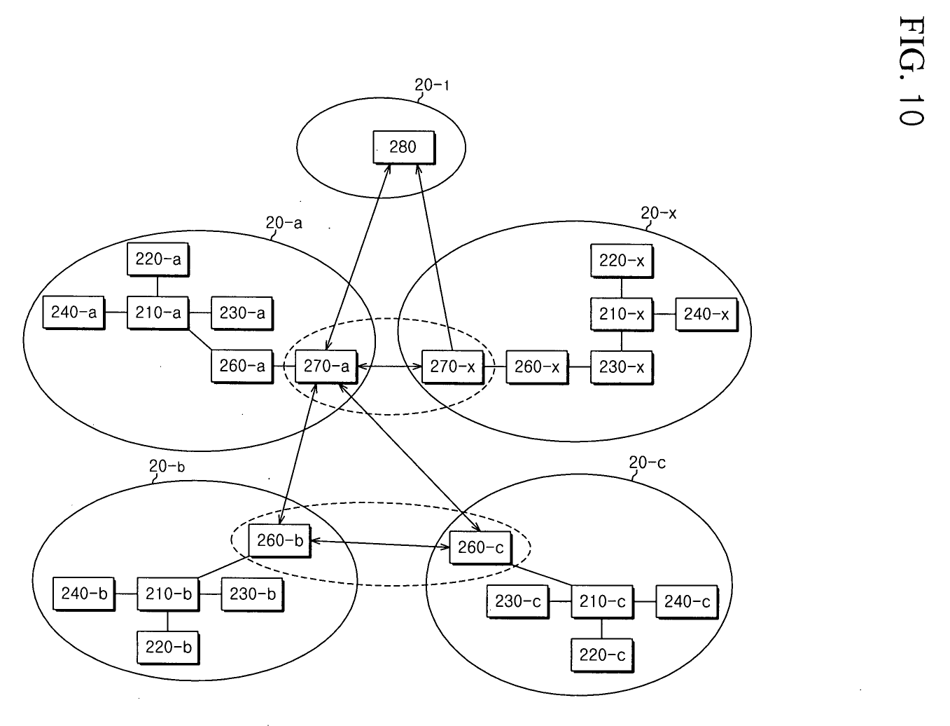

FIGS. 5 and 8 illustrate embodiments where the medical facility data terminals shares medical information vertically (i.e., networking with a tree architecture). Otherwise, the primary tree architecture shown in FIG. 5 can be configured into the networking structure where the lower medical facility data terminals are connected each other, as illustrated in FIG. 9. It is also available for the secondary tree architecture shown in FIG. 6 to be configured into the networking structure where the lower medical facility data terminals are connected each other and the higher medical facility data terminals are connected each other, as illustrated in FIG. 10.

First, referring to FIG. 9, the lower medical facility data terminals 20-2˜20-n form a star-structure networking scheme by means of the medical record reporters 260-2˜260-n respective thereto. While this embodiment shows the star-structure networking scheme between the lower medical facility data terminals 20-2˜20-n positioned under the higher medical facility data terminal 20-1, it is possible to form another star-structure networking scheme for all of the medical facility data terminals 20-1˜20-n without the higher medical facility data terminal (e.g., 20-1).

The medical record reporters 260-2˜260-n, acting as intermediating means for data commonage between the medical facility data terminals, searches and uses necessary data from other medical facility data terminals when the medical facility data terminals form the star-structure networking scheme as in this embodiment.

Next, referring to FIG. 10, the lower medical facility data terminals 20-b˜20-c form a star-structure networking scheme by means of the medical record reporters 260-b˜260-c respective thereto and the higher medical facility data terminals 20-a˜20-x form a star-structure networking scheme by means of the medical record reporting concentrators 270-a˜270-x respective thereto. While this embodiment shows the star-structure networking scheme between the higher medical facility data terminals 20-a˜20-x positioned under the highest medical facility data terminal 20-1, and between the lower medical facility data terminals (e.g., 20-b˜20-c) positioned under the higher medical facility data terminal (e.g., 20-a), it is possible to form another star-structure networking scheme for all of the medical facility data terminals without the highest or the higher medical facility data terminal.

Therefore, the medical facility data terminals applicable to the present invention implements a networking scheme capable of sharing data horizontally, vertically as well. When it needs information, the information can be obtained from searching the medical record database of other medical facilities by means of one of the medical record reporter, the medical record reporting concentrator, and the higher medical record reporting concentrator.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

The present invention described above is advantageous to implementing a paperless hospital by storing the diagnosis and treatment records of patients in computerized forms and providing the records to the patients through a communication network. With the computerization of the diagnosis and treatment records, the medical technologies can be advanced from studies for prescriptions and preventions against various diseases, and also from the commonage of information between medical facilities by way of the networking scheme.

Moreover, a patient can be provided with proper diagnosis and treatment on basis of his private case history because he is able to manage his own diagnosis and treatment record by himself and to show the record to a medical staff if necessary. In addition, the decision supporting system to repeatedly confirm the adequateness of diagnosis and treatment by a medical staff may contribute to verify the validity of the diagnosis and treatment affairs and to prevent medical accident.

Consequently, the present invention is capable of preventing ineffective medical services, reducing the misuse and abuse of health foods and medicines due to incorrect information, and accomplishing individualized medical affairs of medicine prescriptions and dietetic treatments. Thus, it can reduce a cost for medical treatment according to an increase of the old, providing efficient and high-quality medical services with a small cost.

1. A unified medical information management system comprising:
plurality of medical facility data terminal associated with a communication interface and storing diagnosis and treatment information of a patient; and
a medical information management home system receiving individual diagnosis and treatment information from the medical facility data terminal by way of the communication interface;
wherein the medical facility data terminal transfers the coded diagnosis and treatment information with a code in a predetermined form of message; and
wherein the medical information management home system comprises: a database storing the diagnosis and treatment information; and an exclusive coding and decoding processor decoding the coded diagnosis and treatment information transferred from the medical facility data terminal.

2. The unified medical information management system according to claim 1, further comprising a portable terminal storing the individual diagnosis and treatment information from the medical facility data terminal and transferring the stored diagnosis and treatment information to the medical information management home system.

3. The unified medical information management system according to claim 2, wherein the portable terminal is one among a smart card, a mobile communication terminal having a smart card chip, a post-PC, and a portable PC exclusive to medical information.

4. The unified medical information management system according to claim 2, wherein the medical facility data terminal and the portable terminal are connected to each other by way of an HL7 interface; and wherein a message form to compose the diagnosis and treatment information is one of a clinical document architecture and a clinical document architecture associated with an HL7 interface engine or a tool kit.

5. The unified medical information management system according to claim 1, wherein the medical facility data terminal and the medical information management home system are connected to each other by way of an HL7 interface; and wherein a message form to compose the diagnosis and treatment information is one of a clinical document architecture and a clinical document architecture associated with an HL7 interface engine or a tool kit.

6. The unified medical information management system according to claim 2, further comprising an intelligent decision supporting system: connected to the medical information management home system by way of a communication network; analyzing the validity of the diagnosis and treatment information in accordance with that the diagnosis and treatment information is stored in the medical information management home system; and providing the analyzed result to the medical information management home system.

7. The unified medical information management system according to claim 2, further comprising an intelligent decision supporting system: connected to the medical information management home system by way of a communication network; analyzing the validity of the diagnosis and treatment information in accordance with that the diagnosis and treatment information is stored in the medical information management home system; and providing the analyzed result to the medical information management home system or the portable terminal.

8. The unified medical information management system according to claim 1, wherein the medical information management home system further comprises decision supporting means configured to analyze the validity of the diagnosis and treatment information and to provide the analyzed result, in accordance with that the diagnosis and treatment information is stored in the medical information management home system.

9. The unified medical information management system according to claim 8, wherein the decision supporting means outputs the analyzed result of the diagnosis and treatment information through the medical information management home system.

10. The unified medical information management system according to claim 2, wherein the medical information management home system further comprises decision supporting means configured to analyze the validity of the diagnosis and treatment information and to provide the analyzed result, in accordance with that the diagnosis and treatment information is stored in the medical information management home system; and wherein the decision supporting means transfers the analyzed result to the portable terminal.

11. The unified medical information management system according to claim 1, wherein the medical facility data terminal comprises:
a medical record mediator receiving the diagnosis and treatment information of the patient and providing the diagnosis and treatment information of the patient in response to a request of a user;
a medical record managing unit creating, managing, and storing the diagnosis and treatment information in a predetermined document format inputted through the medical record mediator, classifying the diagnosis and treatment information by categories, and evaluating a disease referring to the diagnosis and treatment information;
a medical information database storing the diagnosis and treatment information by the medical record managing unit; and
a medical record reporter monitoring the medical record database in response to a request of the medical record mediator.

12. The unified medical information management system according to claim 11, wherein the medical record mediator comprises:
interface means configured to receive data from the user and to output data required by the user;
certification means configured to confirm that the user is authorized; and
a search engine searching for the diagnosis and treatment information in response to a request of the user.

13. The unified medical information management system according to claim 11, wherein the medical record managing unit comprises:
data updating means configured to store the diagnosis and treatment information, which is inputted through the medical record mediator, in the database, to correct the diagnosis and treatment information, and to add new data on the diagnosis and treatment information;
data grouping means configured to classify the diagnosis and treatment information into plural categories; and
data associating means configured to examine relations between the diagnosis and treatment information.

14. The unified medical information management system according to claim 11, wherein a message form generating the diagnosis and treatment information in the medical record managing unit is one of a clinical document architecture and a clinical document architecture associated with an HL7 interface engine or a tool kit.

15. The unified medical information management system according to claim 11, wherein when the plural medical facility data terminals are connected to each other by way of a communication network, the medical record reporter requests and receives diagnosis and treatment information from another medical facility and carries out an intermediating function to provide the diagnosis and treatment information stored in the medical record database in response to another medical facility.

16. The unified medical information management system according to claim 11, wherein the medical facility data terminal is connected to at least more one of the medical facility data terminals by way of a communication network and one of the medical facility data terminals is a higher medical facility data terminal including a medical record reporting concentrator for transceiving data with another medical facility data terminal; and
wherein the medical facility data terminals except the higher medical facility data terminal function as lower medical facility data terminals transceiving data with a medical record reporting concentrator of the higher medical facility data terminal by means of the medical record reporters.

17. The unified medical information management system according to claim 16, wherein the lower medical facility data terminals are connected to each other by the medical record reporters.

18. The unified medical information management system according to claim 11, wherein the medical facility data terminal is connected to the plural medical facility data terminals by way of a communication network and one of the medical facility data terminals is the highest medical facility data terminal including a higher medical record reporting concentrator for transceiving data with another medical facility data terminal;
wherein more than two of the medical facility data terminals except the highest medical facility data terminal are higher medical facility data terminals each including a medical record reporting concentrator for transceiving data with another medical facility data terminal; and
wherein the medical facility data terminals except the highest and higher medical facility data terminals function as lower medical facility data terminals transceiving data with the higher medical facility data terminal by means of the medical record reporters.

19. The unified medical information management system according to claim 18, wherein the higher medical facility data terminals are connected to each other by the medical record reporting concentrators and the lower medical facility data terminals are connected to each other by the medical record reporters.

20. A method of managing medical information in a unified medical information management system having a plurality of medical facility data terminal associated with a communication interface and storing diagnosis and treatment information of a patient, and a medical information management home system receiving individual diagnosis and treatment information from the medical facility data terminal by way of the communication interface, the method comprising;
storing the diagnosis and treatment information by the medical facility data terminal in accordance with an input of the diagnosis and treatment information of a patient into the medical facility data terminal by a medical staff;
transferring the diagnosis and treatment information to the medical information management home system of the patient through a communication network by the medical facility data terminal; and
storing and outputting the diagnosis and treatment information by the medical information management home system.

21. The method according to claim 20, wherein the diagnosis and treatment information is stored by means of one of a clinical document architecture and a clinical document architecture associated with an HL7 interface engine or a tool kit.

22. The method according to claim 20, further comprising:
transferring the diagnosis and treatment information to a portable terminal of the patient by the medical facility data terminal before the medical facility data terminal transfers the diagnosis and treatment information to the medical information management home system; and
transferring the diagnosis and treatment information to the medical information management home system.

23. The method according to claim 20, wherein the medical information management home system receives the diagnosis and treatment information by means of a communication method using an HL7 interface.

24. The method according to claim 20, wherein the medical information management home system is connected to an intelligent decision supporting system by way of a communication network and the method further comprises:
analyzing the validity of the diagnosis and treatment information by the intelligent decision supporting system with reference to a case history of the patient previously stored in the medical information management home system before the medical information management home system outputs the diagnosis and treatment information; and
storing a result of the analysis from the intelligent decision supporting system, together with the diagnosis and treatment information.

25. The method according to claim 20, further comprising:
analyzing the validity of the diagnosis and treatment information with reference to a case history of the patient previously stored in the medical information management home system before the medical information management home system outputs the diagnosis and treatment information; and
storing a result of the analysis in the medical information, together with the diagnosis and treatment information.

26. The method according to claim 20, further comprising:
transferring the diagnosis and treatment information to another medical facility data terminal in response to a request of the patient after the medical information management home system outputs the diagnosis and treatment information;
transferring a prescription reference document for the diagnosis and treatment information to the medical information management home system, the prescription reference document being composed with reference to the diagnosis and treatment by another medical facility data terminal that received the diagnosis and treatment information; and
displaying the prescription reference document by the medical information management home system.
